(19) United States
(12) Patent Application Publication
(10) Pub. No.: US 2025/0371075 A1
(43) Pub. Date: Dec. 4, 2025

(54) AI-BASED CONTENT TRANSFORMATION INTO DIAGRAMS

(71) Applicant: Microsoft Technology Licensing, LLC, Redmond, WA (US)

(72) Inventors: Shubham GOYAL, Calgary (CA); Daniel Alberto CASTELLON, Ayer, MA (US); Kunal Prakash MISHRA, Bellevue, WA (US); Sarah Ragab Ismail SALEH, Vancouver (CA); Dhruv KOCHHAR, Ottawa (CA); Liang-Ming CHEN, Redmond, WA (US); Jairo MEDINA GARCIA, Redmond, WA (US); Arun LAKSHMANAN, Redmond, WA (US); Amin PIRZADEH, Kirkland, WA (US); William Ross LYNCH, Port Moody (CA)

(73) Assignee: Microsoft Technology Licensing, LLC, Redmond, WA (US)

(21) Appl. No.: 18/678,134

(22) Filed: May 30, 2024

(51) Int. Cl. G06F 16/901; G06F 16/332; G06F 40/30

(52) U.S. Cl. CPC G06F 16/9024; G06F 16/3329; G06F 40/30

(57) ABSTRACT

A data processing system implements receiving a user prompt requesting a diagram representing digital content; constructing a prompt including the user prompt, the digital content, and instructions to a generative model to identify semantic context of the digital content, to identify a text data item, an audio data item, a video data item, and/or a structured file item embedded in the digital content to generate at least one of a text transcript of the audio/video/structure file item, and/or a text description of the audio/video/structure file item, to semantically analyze and extract diagram data from the text data item, the text transcripts, and/or the textual descriptions based on the semantic context, and to generate the diagram of the digital content based on the diagram data; providing the prompt to the generative model and receive the diagram; and providing the diagram to the client device for display.

### BACKGROUND

Modern life is busy and demanding with many different types of personal and work information. Daily content consumption is a powerful tool for both learning and working. Common strategies to improve the time required for content consumption include converting content information into diagrams. Artificial intelligence (AI) has been used to automate our lives to save time and increase productivity. However, the existing AI content management solutions primarily focuses on text. While such content are useful for many users, for users who are visual thinkers and learners, textual contents are not as helpful as diagrams. Hence, there is a need for providing systems and methods of AI-based content transformation into diagrams for content consumption.

### SUMMARY

An example data processing system according to the disclosure includes a processor and a machine-readable medium storing executable instructions. The instructions when executed cause the processor alone or in combination with other processors to perform operations including receiving, via a client device, a user prompt requesting a diagram representing digital content, wherein the digital content includes any of text, audio, video, or structured file; constructing, via a prompt construction unit, a first prompt by appending the user prompt and the digital content to a first instruction string, the first instruction string including instructions to a generative model to identify semantic context of the digital content based on metadata of the digital content, to identify at least one of a text data item, an audio data item, a video data item, or a structured file item, embedded in the digital content to generate at least one of a text transcript of the audio data item, a text transcript of the video data item, a text transcript of the structured file item, a text description of the audio data item, a textual description of the video data item, or a text description of the structured file item, to semantically analyze and extract diagram data from at least one of the text data item, the text transcripts, or the textual descriptions based on the semantic context, and to generate the diagram of the digital content based on the diagram data; providing, via the prompt construction unit, as an input the first prompt to the generative model and receiving as an output the diagram from the generative model; and providing the diagram to the client device to be presented on a user interface of the client device.

An example method implemented in a data processing system includes receiving, via a client device, a user prompt requesting a diagram representing digital content, wherein the digital content includes any of text, audio, video, or structured file; constructing, via a prompt construction unit, a first prompt by appending the user prompt and the digital content to a first instruction string, the first instruction string including instructions to a generative model to identify semantic context of the digital content based on metadata of the digital content, to identify at least one of a text data item, an audio data item, a video data item, or a structured file item, embedded in the digital content to generate at least one of a text transcript of the audio data item, a text transcript of the video data item, a text transcript of the structured file item, a text description of the audio data item, a textual description of the video data item, or a text description of the structured file item, to semantically analyze and extract diagram data from at least one of the text data item, the text transcripts, or the textual descriptions based on the semantic context, and to generate the diagram of the digital content based on the diagram data; providing, via the prompt construction unit, as an input the first prompt to the generative model and receiving as an output the diagram from the generative model; and providing the diagram to the client device to be presented on a user interface of the client device.

An example non-transitory computer readable medium data processing system according to the disclosure on which are stored instructions that, when executed, cause a programmable device to perform functions of receiving, via a client device, a user prompt requesting a diagram representing digital content, wherein the digital content includes any of text, audio, video, or structured file; constructing, via a prompt construction unit, a first prompt by appending the user prompt and the digital content to a first instruction string, the first instruction string including instructions to a generative model to identify semantic context of the digital content based on metadata of the digital content, to identify at least one of a text data item, an audio data item, a video data item, or a structured file item, embedded in the digital content to generate at least one of a text transcript of the audio data item, a text transcript of the video data item, a text transcript of the structured file item, a text description of the audio data item, a textual description of the video data item, or a text description of the structured file item, to semantically analyze and extract diagram data from at least one of the text data item, the text transcripts, or the textual descriptions based on the semantic context, and to generate the diagram of the digital content based on the diagram data; providing, via the prompt construction unit, as an input the first prompt to the generative model and receiving as an output the diagram from the generative model; and providing the diagram to the client device to be presented on a user interface of the client device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 is a diagram of an example computing environment in which the techniques for providing AI-based content transformation into diagrams are implemented.

FIGS. 2A-2B are conceptual diagrams of an AI-based content transformation into diagram pipeline of the system of FIG. 1 according to principles described herein.

FIGS. 3A-3E are diagrams of example user interfaces of an AI-based content generation application that implements the techniques described herein.

FIG. 4 is a flowchart of an example process for providing AI-based content transformation into diagrams according to the techniques disclosed herein.

FIG. 5 is a block diagram showing an example software architecture, various portions of which may be used in conjunction with various hardware architectures herein described, which may implement any of the described features.

FIG. 6 is a block diagram showing components of an example machine configured to read instructions from a machine-readable medium and perform any of the features described herein.

### DETAILED DESCRIPTION

Systems and methods for using generative AI for generating diagrams for content of interest are described herein. These techniques provide a technical solution to the technical problems of converting content into diagram(s), processing content data in real-time, and the like. The existing AI-based content management mechanisms provide textual content. However, according to user research data, the majority of the human population are visual thinkers and learners. Therefore, visualized content, especially in the form of diagrams, are easier for users to consume.

Human brains are wired to process visual content much faster than text. In addition, a well-designed diagram can convey a lot of information at a glance, whereas text requires reading and interpreting sentence by sentence. An AI-based diagram of content not only can save users' time to consume information, but can also increase users' understanding of the information. The technical problem being addressed is that many users are visual thinkers and learners who would benefit from consuming content that has been transformed into diagrams, a capability that does not currently exist. Current generative models struggle to automatically create diagrams from various data types efficiently due to several technical limitations such as understanding inherent data relationships, data ambiguity (multiple valid interpretations) and incompleteness, choosing the right diagram type, limited control and customization (that require a human touch for clarity and aesthetics), and the like. The proposed system improves diagram creation of content by dividing the content into different data type components (e.g., text, audio, video, or the like), and applying generative model(s) to differentially process the different data type components to extract textual information, thereby generating a diagram based on the extracted textual information using a generative model (e.g., a language model or a multinodal model). The system can automatically extract text from different data types, analyze the text to determine the optimal type of diagram(s) based on contextual information associated with the content, and convert the text into the optimal type of diagram(s).

In one embodiment, different content data types (e.g., text, audio, video, structured files, and the like) from various sources are standardized and/or tokenized (e.g., using open-domain semantic labeling, ODSL) before being provided to the generative models as grounding data. In addition, the system uses the extracted text as input to the generative model, in order to semantically analyze and extract diagram data there from, to then create a diagram of the content for user visual consumption of the content.

The term “diagram” refers to any kind of illustration or drawing that uses text and visual elements like shapes, lines, arrows, labels, and colors to convey information in any fields from science and engineering to business and education, shows how different parts of the information are connected and interact, and/or applies symbols and abstractions to highlight important aspects of the information it represents. This makes complex information and/or ideas easier to grasp than just reading text. Example diagrams include timeline, flowchart, decision tree, mind map, organization chart, fish bone, bar chart, scatter plot, pie chart, histogram, heat map, Swimland diagram, SIPOC diagram (Suppliers, Inputs, Processes, Outputs, Customers), UML diagram (Unified Modeling Language), and the like.

The term “diagram data” refers to data used to create a diagram of content of interest, i.e., the underlying information used to generate the diagram itself. The data used to create the diagram includes data represented in the diagram, i.e., the information that the diagram conveys. This data could be information to be visually represented, such as sales figures in a bar chart, connections between departments in an organization chart, steps of a marketing plan, and the like.

The term “structured file” refers to a computer file that organizes data in a predefined format. This format typically follows a set of rules that determine how the data is arranged and accessed. Examples of structured files include CSV (Comma-Separated Values), Excel Spreadsheet (XLSX), database files, and the like. Structured files are contrasted with unstructured files, which lack a predefined format. Examples of unstructured files include text documents, images, audio files, and videos.

In another embodiment, the system semantically transforms multimedia content into diagrams, with types of diagrams that may include mind maps, flowcharts, organization charts, fishbone, decision tree, and the like. The system sends prompts requesting the transformation along with a specified intent and a desired level of detail to a large language model (LLM). One aspect includes a user experience (UX) in which the system, responsive to the user request to transform the content into diagram(s), provides diagrams that aid in the more effective consumption of the content by the user, with the ability to iterate and refine the diagrams generated in an interactive manner. Various embodiments of the UX provide tangible results provided by the system to produce different types of diagrams. Another aspect includes a system for semantically transforming multimedia content into diagrams using the method described above.

A technical benefit of the approach provided herein is the diagram of content generated by a generative model visually and semantically representing the content. This result improves the understanding and productivity of the user regarding the content of interest. The diagram of content generated by a generative language model based on contextual features (e.g., semantic context) extracted from metadata, sensor data, and the like can semantically infer the user content and analyzes the content better than a system that does not consider the contextual features.

Another technical benefit of this approach is iteratively refining the output by revisiting and modifying the content generated by the generative language model until the final diagram meets the expected standards and accurately represents the intended information

Another technical benefit of this approach is applying a multimodal generative model (e.g., GPT-4) to efficiently and creatively visualize the content into a diagram.

Another technical benefit of this approach is the automated generation of a diagram of content in various data types/formats, and doing so in a way that takes the relevant contextual information into account when creating a diagram for the content. In particular, the approach builds a data pipeline that can securely extract the content across different sources and ground them to generative models.

Yet, another technical benefit of this approach is providing user interfaces that allow users to interact with the system to edit the diagram of content, provide feedback, and re-generate diagrams of the content based on the feedback. These and other technical benefits of the techniques disclosed herein will be evident from the discussion of the example implementations that follow.

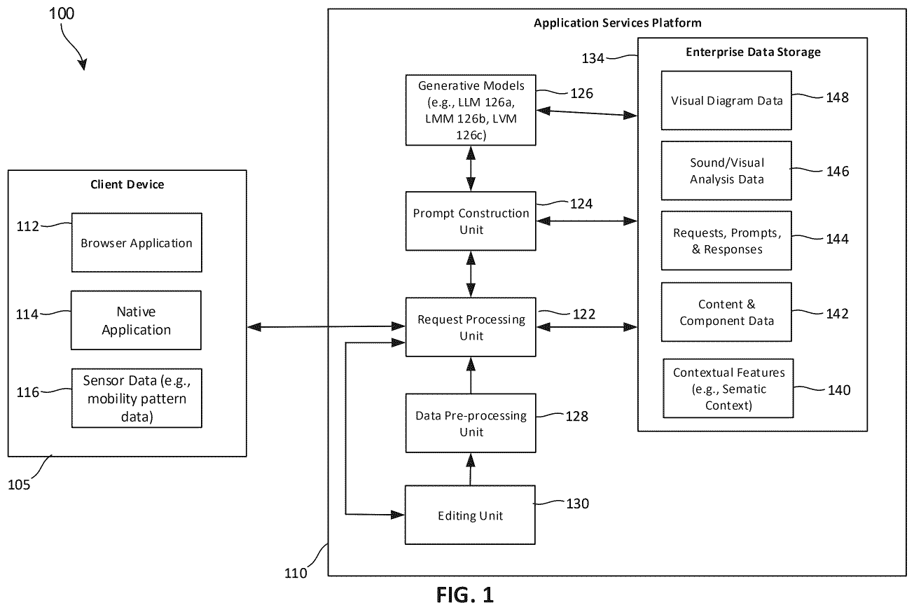

FIG. 1 is a diagram of an example computing environment 100 in which the techniques herein may be implemented. The example computing environment 100 includes a client device 105 and an application services platform 110. The application services platform 110 provides one or more cloud-based applications and/or provides services to support one or more web-enabled native applications on the client device 105. These applications may include but are not limited to diagram generation applications, presentation applications, website authoring applications, collaboration platforms, communications platforms, and/or other types of applications in which users may create, view, and/or modify diagrams of content. In the implementation shown in FIG. 1, the application services platform 110 also applies generative AI to generate fast and concise diagrams of content upon user demand, according to the techniques described herein. In one embodiment, the application services platform 110 is independently implemented on the client device 105. In another embodiment, the client device 105 and the application services platform 110 communicate with each other over a network (not shown) to implement the system. The network may be a combination of one or more public and/or private networks and may be implemented at least in part by the Internet.

The client device 105 is a computing device that may be implemented as a portable electronic device, such as a mobile phone, a tablet computer, a laptop computer, a portable digital assistant device, a portable game console, and/or other such devices in some implementations. The client device 105 may also be implemented in computing devices having other form factors, such as a desktop computer, vehicle onboard computing system, a kiosk, a point-of-sale system, a video game console, and/or other types of computing devices in other implementations. While the example implementation illustrated in FIG. 1 includes a single client device 105, other implementations may include a different number of client devices that utilize services provided by the application services platform 110.

As used herein, the term “content” refers to any information that exists in a format that can be processed by computers. Examples include text documents, images, audio files, videos, software applications, websites, social media posts, and the like. Although various embodiments are described with respect to digital content, it is contemplated that the approach described herein may be used with paper content or content embedded in other physical storage media than paper, which require pre-processing to convert into a digital format.

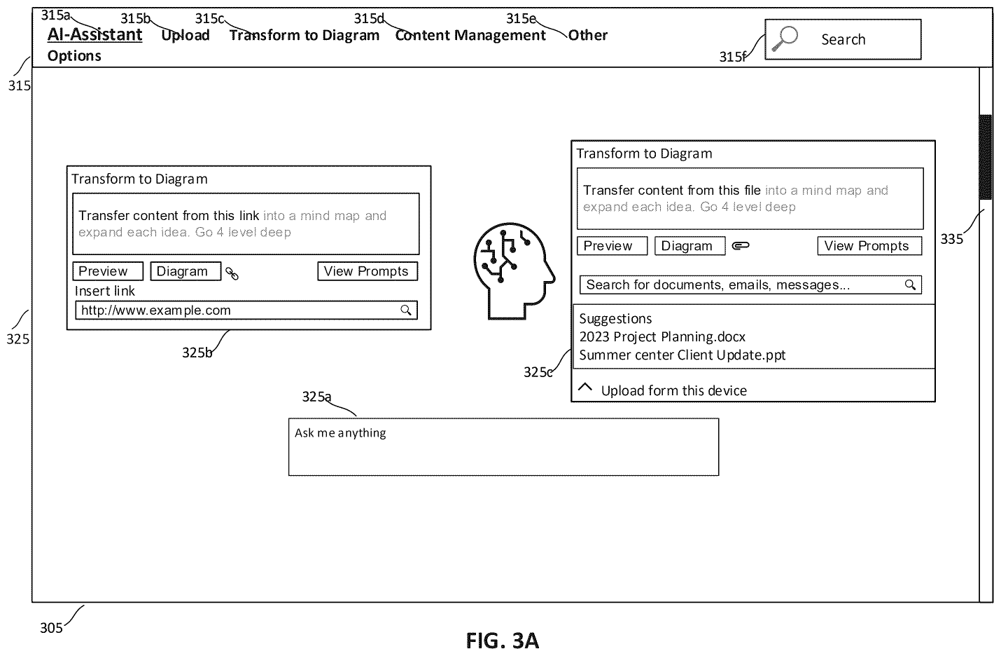

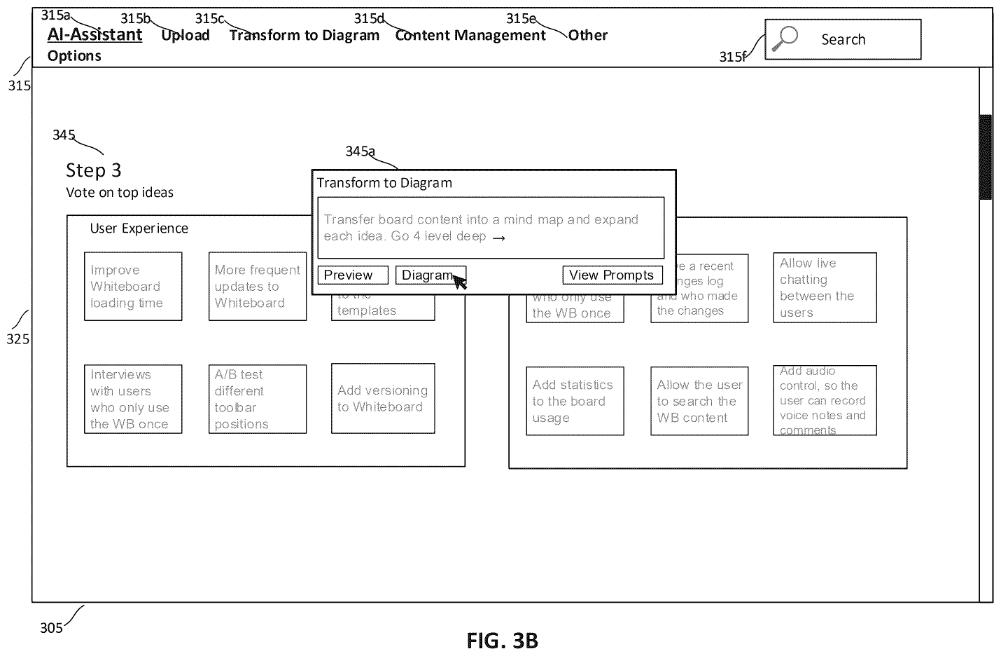

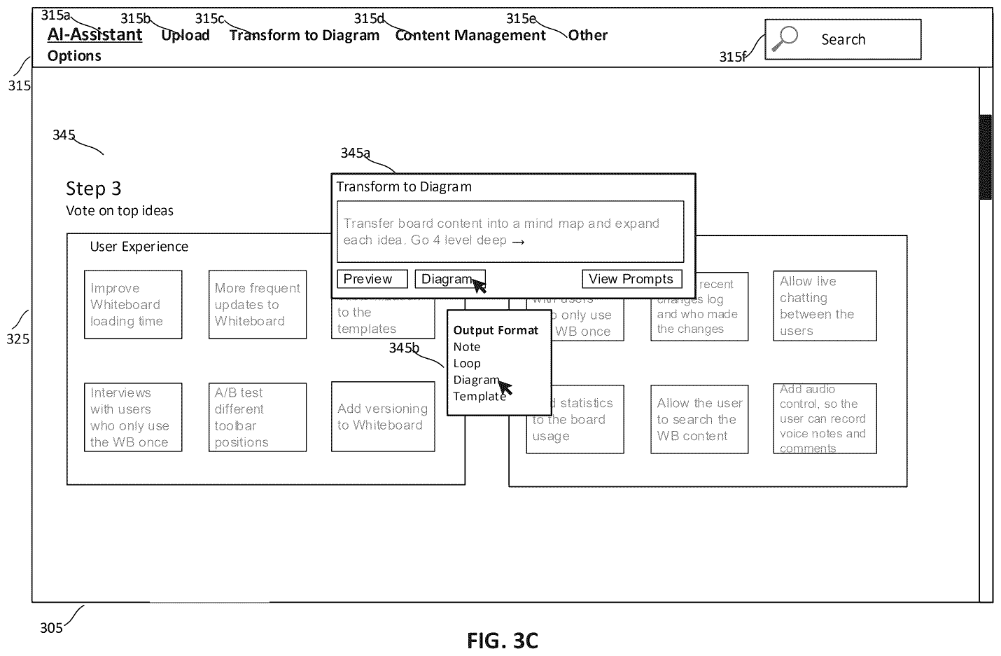

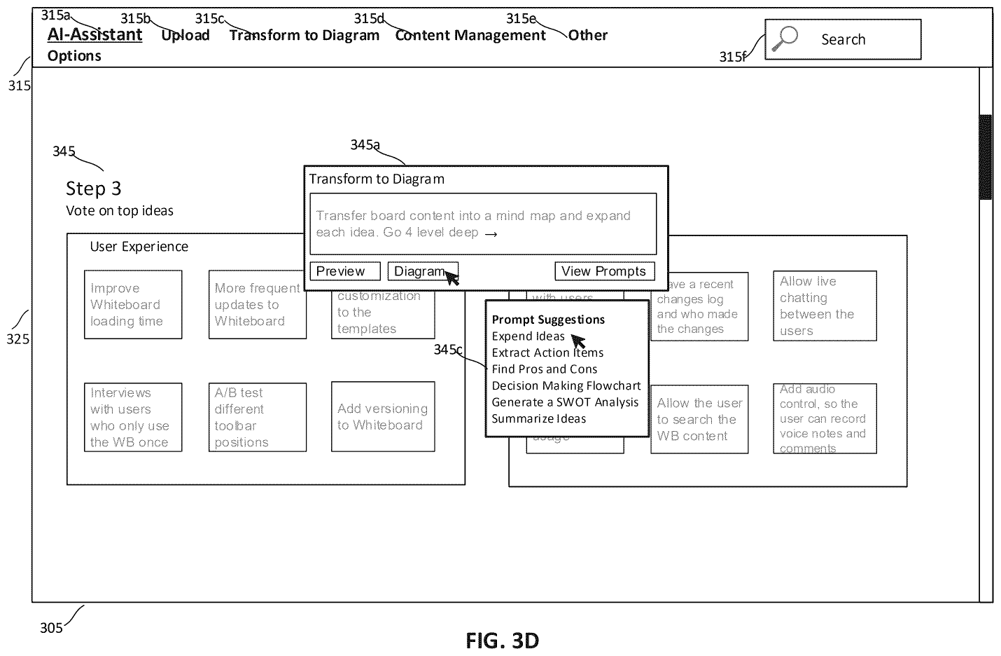

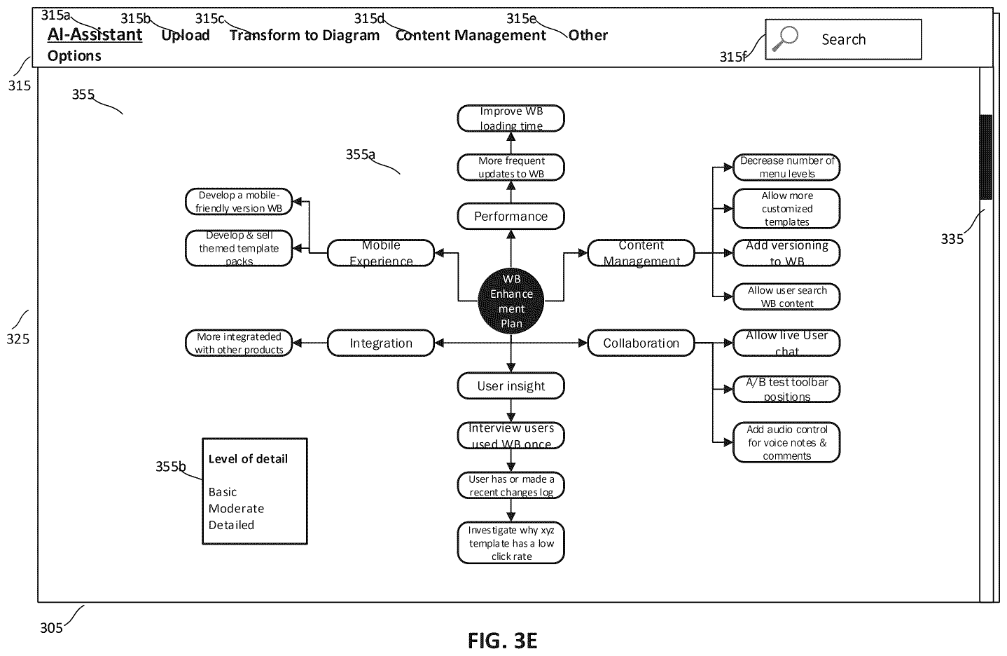

The client device 105 includes a native application 114 and a browser application 112. The native application 114 is a web-enabled native application, in some implementations, which enables users to view, create, and/or modify diagrams of content. The web-enabled native application utilizes services provided by the application services platform 110 including but not limited to creating, viewing, and/or modifying various types of diagrams of content and obtaining content data source(s) for creating and/or modifying the diagrams of content. The native application 114 implements a user interface 305 shown in FIGS. 3A-3E in some implementations. In other implementations, the browser application 112 is used for accessing and viewing web-based content provided by the application services platform 110. In such implementations, the application services platform 110 implements one or more web applications, such as the browser application 112, that enables users to view, create, and/or modify diagrams of content and to obtain content data for creating and/or modifying diagrams of content. The browser application 112 implements the user interface 305 shown in FIGS. 3A-3E in some implementations. The application services platform 110 supports both the native application 114 and the browser application 112 in some implementations, and the users may choose which approach best suits their needs.

In one embodiment, the application services platform 110 includes a request processing unit 122, a prompt construction unit 124, generative models 126, a data pre-processing unit 128, and an editing unit 130. In other embodiments, the application services platform 110 also includes an enterprise data storage 134, and moderation services (not shown).

The request processing unit 122 is configured to receive requests from the native application 114 and/or the browser application 112 of the client device 105. The requests may include but are not limited to requests to create, view, and/or modify various types of diagrams of content and/or sending natural language prompts to a generative model 126 to generate a diagram of content according to the techniques provided herein. The request processing unit 122 also coordinates communication and exchange of data among components of the application services platform 110 as discussed in the examples which follow.

In one embodiment, the generative models 126 include a generative model trained to generate content (e.g., textual, spreadsheet, chart, report, audio, image, video, and the like) in response to natural language prompts input by a user via the native application 114 or via the web. For instance, the generative models 126 are implemented using a large language model (LLM) in some implementations. Examples of such models include but are not limited to a Generative Pre-trained Transformer 3 (GPT-3), GPT-4 model. For instance, the generative models 126 are implemented using a multimodal model (e.g., GPT-4V, GPT-4o, and the like) in some implementations. Developing an AI model capable of extracting text from different data/file types and determining optimal diagrams to express the text data requires training on large and diverse datasets, thereby ensuring that the generated diagrams are relevant and accurately reflect the content of interest. Other implementations may utilize machine learning models or other generative models to generate a diagram of content according to contextual features of the content and/or preferences of a user. In terms of structured diagram creation, the system can leverage AI orchestration engines (e.g., Microsoft Semantic Kernel®) as a middle layer between the user and various AI models, and diagramming tools/plugins to generate structed diagram(s) representing the specific elements and relationships of the content of interest in a structured way. For instance, the generative model creates initial ideas and determines the specific relationships between content elements, and then refines the relationships into a structured diagram using diagramming software (e.g., Lucidchart®, Microsoft Visio®, or the like).

In one scenario, the AI-based content transformation into diagram pipeline 200 creates a diagram of ideated content on Whiteboard® generated by a product development team of a software company. Microsoft Whiteboard® meetings are designed to be collaborative brainstorming sessions, and the outputs can vary depending on the meeting's purpose. Microsoft Whiteboard® itself does not have a native file format to save the entire collaborative workspace. However, it offers two main export options for capturing the Whiteboard® content: Portable Network Graphic (PNG) images and Scalable Vector Graphics (SVG) images.

In one embodiment, the request processing unit 122 receives the user request to generate a diagram of the content from the native application 114 or the browser application 112. For instance, the user request is a natural language prompt input by the user which is then passed on to the prompt construction unit 124. For example, the user request is expressed in a user prompt such as “help me generate a diagram of the uploaded content,” or “I want to use ChatGPT to transform the Whiteboard® content in a diagram.”

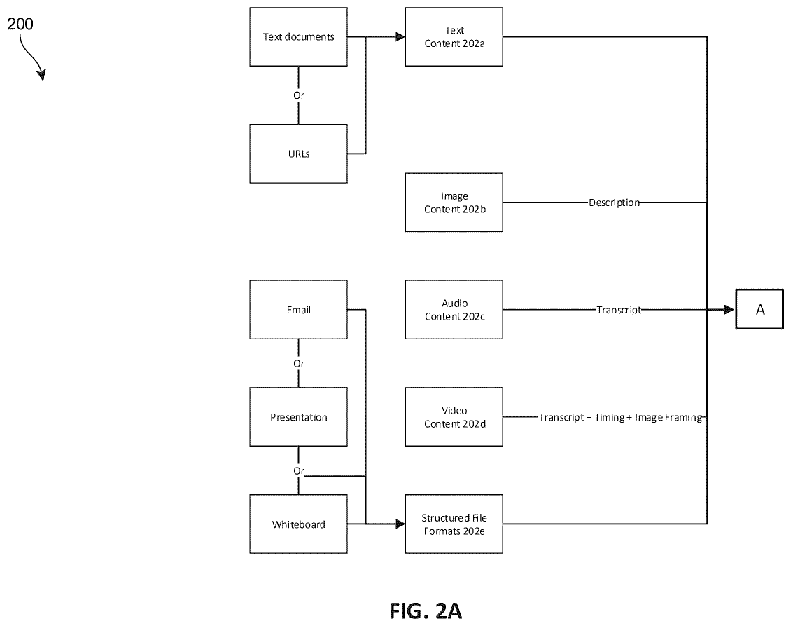

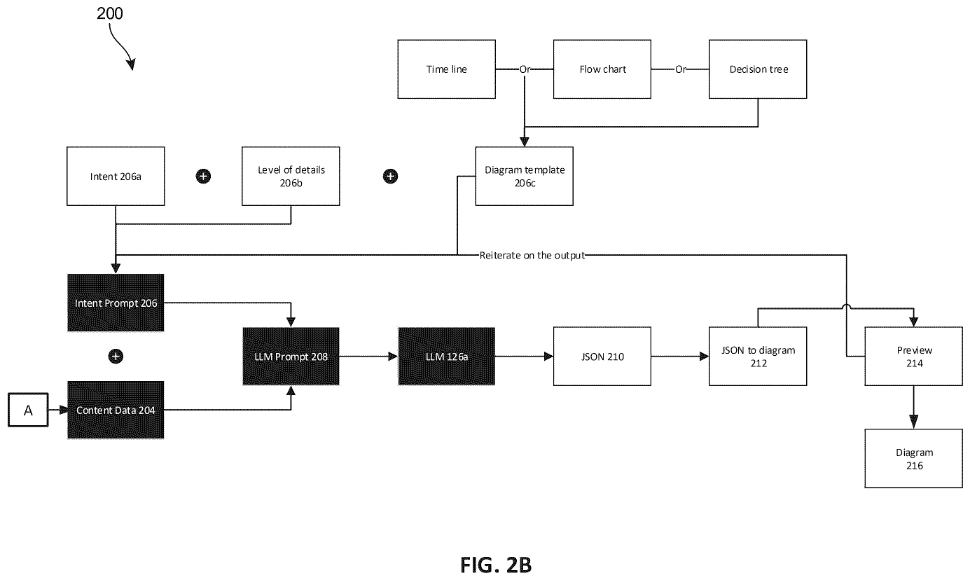

The generative models 126 ground on the provided content to create a draft diagram for preview. For example, the natural language prompt calls a LLM 126a to process different data type components of the content to get text and/or audio components of the content, and then call a LMM 126b or a LVM 126c to generate a diagram of the content based on the outputs from the LLM 126a. A meta prompt for the LLM 126a may imply or indicate that the user would like to have the different data type components of the content processed differently, as described in the AI-based content transformation, into the diagram pipeline 200 in FIGS. 2A-2B.

Once the prompt construction unit 124 interprets that the user prompt is for generating a diagram of the content, the prompt construction unit 124 can formulate meta-prompt(s) for generating a diagram of the content. The prompt construction unit 124 can divide different data type components of the content (e.g., notes that have reactions), and selectively choose data type(s) to generate textual data for generating the diagram.

In an example, a team of product managers working on a digital whiteboard product (e.g., Microsoft Whiteboard®) are working to increase revenue, improve user experience and improve product retention. They starts a Teams® meeting and a Microsoft Whiteboard® to ideate collaboratively a number of ideas in sticky notes with votes and reaction stickers. The team lead then decides to visualize the discussion as a mind map by invoking a “Transform to diagram” functionality from a Copilot® interface (either from the chat or from a contextual UI). The team lead also expands on each idea to have discussions to evaluate each idea using the prompt in Table 1. This prompt can be entered by a user, or coded as a “canned prompt” for the user to select (e.g. “Expand Ideas” among the prompt suggestions in FIG. 3D). Upvotes in Microsoft Whiteboard are a way for collaborators to indicate their preference for specific ideas or suggestions, i.e., a thumbs-up mechanism for virtual sticky notes. As such, the LLM 126a semantically infers the user intent and creates a mind map visualizing the shared ideas and going a level deeper to expand on the ideas.

TABLE 1

Transform content in sticky notes having upvotes from whiteboard
titled “Name of whiteboard” into a 4-level mind map & expand on
each idea. Color-code the mind map nodes based on the note
color & adjust node size based on number of upvotes with ideas
having more upvotes, visualized in larger nodes & vice versa.

The draft diagram can be presented to the user for editing (e.g., by adding comments, annotations, reactions, etc.). Once the edits are done, the user can publish the diagram, for example, which may be inserted as a Stream® Loop® component on the Whiteboard®. In this case, the system can publish/paste the Stream® Loop® component to other Loop hosts, such as Teams® chats/channels, Outlook® mails, Loop® App, and the like.

FIGS. 2A-2B are conceptual diagrams of an AI-based content transformation into diagram pipeline 200 of the system of FIG. 1 according to principles described herein. FIG. 2A shows the upstream of the pipeline 200 for converting a media content input into a diagram.

The pipeline 200 can process various forms of media content of interest, including text content 202a (e.g., text documents, URLs, and the like), images content 202b, audio content 202c, video content 202d, and structured file content 202e (e.g., emails, presentations, whiteboards, and the like). In another embedment, the content of interest includes one or more of the media content types, such that the pipeline 200 divides the content of interest into one or more components: text content 202a, audio content 202c, images content 202b, audio content 202c, video content 202d, and structured file content 202e. The content of interest may contain one or more of these components, as well as other data types such as spreadsheet, chart, and the like.

The pipeline 200 can use LLMs throughout the transformation pipeline 200. The transformation pipeline 200 involves interpreting these media forms into text when necessary, such as converting the image content 202b into descriptions, converting the audio content 202c into transcripts, dividing and converting the video content 202d into transcripts, timing data, image frames, and the like. The interpreted data is assembled into content data 204 for processing. Continuing to FIG. 2B, the pipeline 200 assembles an intent prompt 206 based on any specified intent 206a, level of detail 206b, and/or diagram form 206c (e.g., a timeline, a flowchart, a decision tree, or the like). The pipeline 200 then combines the content data 204 with the intent prompt 206 into a system prompt 208 for a generative model (e.g., the LLM 126a). This system prompt 208 is processed by the LLM 126a to generate a JSON structure 210. This JSON structure 210 is subsequently translated in a visual preview step 212 into a draft diagram 214 representing the interim stage of the diagram's development.

The draft diagram 214 can take the form of a timeline, flowchart, decision tree, and so on, depending on the requirements specified in the intent prompt 206 and/or the system prompt 208. The pipeline 200 is designed to be iterative, allowing for refinement of the output by revisiting and modifying the content generated by the LLM 126a until the final diagram meets the expected standards and accurately represents the intended information.

Comparing with creating diagrams through only user-provided text prompts, transforming existing multimedia content to diagrams has unique utility for end-users via digesting large content into diagrams and avoiding cold start problems. In addition, the system can incorporate into the system prompt 208 one or more predetermined prompts, such as expending ideas, extracting action items, finding pros and cons, decision making flowchart, generating a SWOT analysis, or summarizing ideas, to generate different diagrams. For example, the client device 105 has a document open thereon, and the content of interest in the document is used for grounding AI outputs. There are two main ways to ground/connect the AI outputs to sources of information. One is data source access and the other is prompt engineering. These methods tether the AI's creations to reality thereby reducing the chances of AI hallucination.

In addition to the explicit grounding, the pipeline 200 applies implicit grounding (e.g., via Sydney®, an AI chatbot) to add additional contextual features (including semantic context) to the AI-model inputs. Implicit grounding refers to the ability of a generative AI model to understand and reference the real world without being explicitly programmed about it. This means the model learns the semantic context (e.g., people, places, events, other relevant attributes), styles, names, inner relationships, and the like of the content through its training data and interactions.

Alternatively, the pipeline 200 can extract the semantic context (e.g., topic/title, speakers, audience, and the like) of the content of interest (e.g., a document) from the metadata of the content. Taking a word document as an example, the document can include several types of metadata, such as document details (e.g., title, author/creator, subject, keywords, and the like), document creation and history (e.g., the date the document was created, the last modified date and time, the total editing time spent on the document, comments and track changes, custom properties defined by users, template information, etc.), and the like.

Audio files can hold metadata that helps identify, organize, and recommend the audio content, such as basic information (e.g., artist name, album title, track title, track number, and release date), genre (e.g., rock, pop, classical, etc.), composer/writer credits, album artwork (e.g., cover art for the album the audio file belongs to, copyright information, licensing, mood/energy, and the like), lyrics, and the like. This metadata is typically stored within the audio file itself using tags like ID3v1 and ID3v2. Not all audio formats support extensive metadata tagging, yet popular formats like MP3 and WAV do.

Video files carry video metadata similar to audio files including the basic information and actors, directors, location filming (e.g., geotags), non-human characters in the video (e.g., for animation or gaming content), file format and size (e.g., MP4, AVI), video and audio codecs, resolution and frame rate, copyright and licensing, ratings and restrictions, chapter markers, and the like.

Structured files (e.g., emails, presentations, and the like) have various metadata. For instance, email messages contain metadata about the email itself (e.g., the email address of the sender, the email address(es) of the recipient(s), the subject line of the email, date, or the like), separate from the content within the email body. This metadata provides details about the email's journey and helps with organization and filtering the email content. As another example, the metadata of a PowerPoint presentation includes the name/subject/author of the presentation, relevant keywords or tags associated with the presentation content, notes or comments added by the author about the presentation, the category or type of presentation (e.g., business meeting, sales pitch, educational lecture), and the like.

In one embodiment, the AI-based content transformation into diagram pipeline 200 builds a data pipeline that can securely filter the content across different sources and ground them to the generative models 126. In one embodiment, the data pipeline builds a staging area to collect data across different applications that could be relevant for a use case. The data pipeline also builds a data streaming system apt to speed up the process. The data is tokenized before being fed to the LLM 126a. As such, the AI-based content transformation into diagram pipeline 200 can integrate the LLM 126a with various sources of input data, such as documents, meeting transcripts, and recordings. For example, Copilot AutoGen can assist a process of data cleansing.

In another embodiment, the AI-based content transformation into diagram pipeline builds a data orchestration system based on AutoGen®, where each Agent covers specific sources of input data (i.e. each one of the app-specific data sources, integration with App Chat Copilot®), and deploys respective LLMs and tools (e.g., sound/speech analysis tools, visual analysis tools, and the like). AutoGen® is an open-source, community-driven project that provides a multi-agent conversation framework as a high-level abstraction. The AI-based content transformation into diagram pipeline 200 applies handoff implementation for each specific application so that the application can communicate properly with a respective Agent from the AutoGen-based orchestration framework.

In one embodiment, the AI-based content transformation into diagram pipeline 200 uses a cloud storage service/platform (e.g., Stream®, a corporate video-sharing service) as a standard for creating video content. Taking a virtual work meeting (e.g., via Teams®) as an example, the pipeline 200 uses a meeting recording in Stream®, leverages Stream® for diagram creation, and stores the diagram (e.g., in OneDrive® and SharePoint®). Further, the pipeline 200 can leverage an online collaboration application (e.g., Loop®) component for Stream® to easily port and edit the diagram across different applications (e.g., applications of M365® suite).

In another embodiment, the pipeline 200 can extract the semantic context of the content of interest from sensor data 116 of the client device 105. (e.g., user mobility pattern data collected by a GPS receiver of the client device 105). For example, the pipeline 200 can retrieve sensor data that indicates the user sang and recorded a discussion at an airport terminal from 5:00-5:30 pm without saying the location and the timing. The location and timing data can be the semantic context to be incorporated in a diagram of the discussion.

The preliminary/draft diagram 214 can be created for preview. The user has the ability to change/edit the draft diagram 214 and/or interact (through comments, annotations, etc.) with the draft diagram 214. Upon user confirmation, a final diagram 216 is published.

When the content of interest contains only the text content 202a (e.g., a Word document), the pipeline 200 can apply an LLM or LMM and a meta prompt (e.g., Table 2) to semantically analyze the text, or to semantically analyze the text further based on the semantic context (e.g., details pertaining to contributors, reviewers, key sections and important insights) to get diagram data. The pipeline 200 then sends the diagram data to the LMM to generate the draft diagram 214.

TABLE 2

Create a diagram from the Word document titled
[Document_Name] while including details pertaining
to contributors, reviewers, key sections & important insights.

When the content of interest contains only the audio content 202c, the AI-based content transformation into diagram pipeline 200 applies the LLM/LMM on the audio content 202c to generate a text transcript, and to semantically analyze the text transcript to get diagram data. The pipeline 200 can semantically analyze the text transcript 202b-1 further based on the semantic context to get diagram data. The pipeline 200 then sends the diagram data to the LVM or the LMM to generate the draft diagram 214.

Concurrently or alternatively, the AI-based content transformation into diagram pipeline 200 can apply sound/speech analysis (via machine learning models and/or generative models) on the audio content 202c to generate audio section(s). In one embodiment, the sound/speech analysis is based on tone, intonation, pitch, volume, speaking rate for emphasis, and the like to determine the audio section(s). For example, the sound/speech analysis chooses a loud and long comment as an audio section to include in the draft diagram 214. The pipeline 200 then sends the diagram data and the the audio section(s) to the LVM/LMM to generate the draft diagram 214.

In another instance, the sound/speech analysis further includes considering the semantic context to get audio section(s). For example, the sound/speech analysis chooses a boss's comment as an audio section to include in the draft diagram 214. The AI-based content transformation into diagram pipeline 200 then sends the diagram data and the the audio section(s) to the LVM/LMM based on a meta prompt (e.g., Table 3) to generate the draft diagram 214 further based on the semantic context such as speaker, audience, speaking rate, tone, volume and intonation.

TABLE 3

Create a diagram using the audio & transcript from the meeting
titled [Meeting_Name]. Rank sections in the video output based
on speaker, audience, speaking rate, tone, volume & intonation.

When the content of interest contains only the image/video content 202b/202d, the AI-based content transformation into diagram pipeline 200 can apply the LL M/LMM on the image/video content 202b/202d to generate a text transcript for the video content 202d and/or text descriptions for the image/video content 202b/202d. The text transcript can be extracted from the audio portion of the video content 202d. The text descriptions can be a text summary of the text transcript of the audio portion of the video content 202d, and/or direct visual descriptions of the image/video content 202b/202d based only on the visual portions of the image/video content 202b/202d. The AI-based content transformation into diagram pipeline 200 can apply the LLM/LMM to semantically analyze the text transcript and/or the text descriptions to get diagram data. The pipeline 200 then sends the diagram data to the LVM/LMM to generate the draft diagram 214.

By analogy, the AI-based content transformation into diagram pipeline 200 can apply the sound/speech analysis on the audio portion of the video content 202d to generate audio section(s), then process the audio section(s) as discussed. The pipeline 200 then sends the diagram data and the audio section(s) to the LVM/LMM to generate the draft diagram 214.

Concurrently or alternatively, the AI-based content transformation into diagram pipeline 200 can apply visual analysis on the visual portion of the image/video content 202b/202d to determine scenes. In one embodiment, the visual analysis is based on color, motions, objects, people, and the like to determine the scenes. The pipeline 200 then sends the diagram data and the scenes to the LVM/LMM to generate the draft diagram 214, Alternatively, the pipeline 200 then sends the diagram data, the audio section(s), and the the scenes to the LVM/LMM based on a meta prompt (e.g., Table 4) to generate the draft diagram 214 based on the semantic context such as audience, overall participation, meeting duration, participant sentiment and number, and priority of follow-ups.

TABLE 4

Create a diagram using the meeting video recordings & transcripts
of the last 10 instances of the meeting series titled
[Meeting_Series_Name]. Rank the talking points in the transcript
based on audience, overall participation, meeting duration,
participant sentiment & number + priority of key follow-ups.

When the content of interest contains both the text content 202a and the audio content 202c, the AI-based content transformation into diagram pipeline 200 can semantically analyze the text content 202a and the text transcript 202b-1 to get diagram data. The pipeline 200 then sends the diagram data and/or the audio section(s) to the LVM/LMM to generate the draft diagram 214.

When the content of interest contains both the text content 202a and the image/video content 202b/202d, the AI-based content transformation into diagram pipeline 200 can semantically analyze the text content 202a, the text transcript, and/or the text description to get diagram data. The pipeline 200 then sends the diagram data, the audio section(s), and/or the scenes to the LVM/LMM to generate the draft diagram 214.

In another scenario, the pipeline creates a diagram for a virtual meeting such as a Teams® meeting. A project management team recently concluded a construction project and is having a retrospective meeting. The group leader kickstarts the meeting with recording and transcription. They discuss the various project outcomes and respective hypothesized causes, effects, and impacts. Once the discussion concludes, the group leader calls the LLM 126a (e.g., by invoking Copilot®) using the prompt in Table 5 to recap the meeting. Based on the discussion transcript, the LLM 126a semantically adds a cause-effect diagram (e.g., fishbone) at the bottom of a text-based meeting summary as the meeting record. Upon acceptance by the group leader, the meeting record is circulated among the team.

TABLE 5

Perform a project retrospective using content from Teams meeting
titled “Name of Teams meeting” in the form of a fishbone diagram
with each project feature corresponding to a node in the fishbone.
The size of the nodes should depend on the feature priority
inferred using the crew size, crew lead's seniority level, the
prelim. size estimate for execution & the overall outcome.

In yet another scenario, the AI-based content transformation into diagram pipeline 200 creates a different diagram of change logs for a virtual meeting application such as the Teams® App when a user select a canned prompt in FIG. 3D (e.g., Extract Action Items) using the prompt in Table 6.

TABLE 6

Use the transcript & recording from the meeting titled “Name of
meeting” to extract action items & visualize in the form of a
swim lane diagram with a lane for each meeting participant.
Add task assignee & assign priority based on inferred user intent
through voice tonality & modulation, speech content, pitch & the
seniority of the user proposing the action item.

When the content of interest contains both the audio content 202c and the image/video content 202b/202d, the AI-based content transformation into diagram pipeline 200 can semantically analyze the text transcript and/or the text description to get diagram data. The pipeline 200 can analyze the audio content 202c to get audio section(s), and analyze the image/video content 202b/202d to get scenes. The pipeline 200 then sends the diagram data, the audio section(s), and/or the scenes to the LVM/LMM to generate the draft diagram 214.

When the content of interest contains all of the text content 202a, the audio content 202c, and the image/video content 202b/202d, the AI-based content transformation into diagram pipeline 200 can semantically analyze the text content 202a, the text transcript, and/or the text description to get diagram data. The pipeline 200 can analyze the audio content 202c to get audio section(s), and analyze the image/video content 202b/202d to get scenes. The pipeline 200 then sends the diagram data, the audio section(s), and/or the scenes to the LVM/LMM to generate the draft diagram 214.

Beside standard text, audio, and video formats, the Ali-based content transformation into diagram pipeline 200 can semantically analyze other data types such as the structured file content 202e. For instance, CSV (Comma-Separated Values) stores tabular data like spreadsheets, where each row represents a record, and commas (or other delimiters) separate values within a row. In another scenario, the pipeline 200 creates one or more diagrams for a user's work week, for example, as part of Microsoft Viva® digest. Microsoft Viva®, being a suite of employee experience tools, does not have a single unified output file format. However, the output formats can vary depending on the specific Viva® module. For example, Viva Engage and PowerShell allow exporting Viva Insights data in a CSV format. The user leverages the weekly Microsoft Viva® digest to analyze key trends in the working style pertaining to quiet hours, collaboration time, as well as most engaged meetings, and the like. For instance, the AI-based content transformation into diagram pipeline 200 creates diagrams using the generative models 126 and implicit grounding on the user's content in Substrate (such as W/X/P documents), email and meeting communications, and the like, based on the semantic context such as collaborators, generated output & amount of time invested, as the meta prompt listed in Table 7.

TABLE 7

Create a timeline showcasing the highlights from my work week.
Rank the highlights by involved collaborators, generated output &
amount of time invested. Also call out any top behavioral
patterns for me & ways I can improve my working efficiency.

The AI-based content transformation into diagram pipeline 200 then augments a weekly Microsoft Viva® digest with the diagrams showcasing key highlights from the user's work week, while highlighting key behavioral patterns, top collaborators, and suggestions in the diagram for improving work efficiency.

In yet another scenario, the AI-based content transformation into diagram pipeline 200 creates a diagram of change logs for an online collaboration application (e.g., Loop®). For example, a scrum master runs regular standups in application such as the Loop App in a joint workspace with the crew. The crew members are required to make async updates to the online collaboration workspace a day before the standup, and the updates include relevant code snippet, text and proof of concept (POC) videos showcasing progress. The scrum master wants to quickly review the progress made by the crew since the last standup, and invokes the “Transform to Diagram” functionality for the Loop workspace. The feature leverages AI to utilize the multi-media content added by crew members since the scrum master last viewed the workspace, to create a timeline plot highlighting the time and content added. The plot has separate rows/swim lanes for each crew member which aids the scrum master to quickly gauge (1) who has made relevant updates, and (2) the nature and content of updates made.

The AI-based content transformation into diagram pipeline 200 leverages the video change logs and the generative models 126 using the meta prompt listed in Table 8 to semantically analyze the multi-media content added by crew members (e.g., changes made by a specific user since 3/31) since the scrum master last viewed the workspace, and to create a timeline plot highlighting crew member updates made to the workspace.

TABLE 8
Highlight Loop workspace changes since 3/31.
Semantically analyze the changes made by user A as a timeline plot.

In yet another scenario, the AI-based content transformation into diagram pipeline 200 creates a different diagram of the change logs for the Loop App when a user select a canned prompt in FIG. 3D (e.g., Find Pros & Cons) using the prompt in Table 9.

TABLE 9

Perform a project retrospective using content from Loop workspace
titled “Name of workspace” in the form of a fishbone diagram with
each project feature corresponding to a node in the fishbone with
at least 3 pros & cons branching out from each node. The size of
the nodes should depend on the feature priority inferred using
the crew size, crew lead's seniority level, the prelim. estimate
for execution & the overall outcome.

In yet another scenario, the AI-based content transformation into diagram pipeline 200 creates a diagram for a marketing team of a multinational pharmaceutical company preparing for the launch of a new drug. They are leveraging a team-work planning application (e.g., Microsoft Planner®) for this project management activity and have already created a set of tasks and subtasks for tracking progress. In order to quickly reason the voluminous plan and understand next steps, the project lead uses the prompt in Table 10 to ask the LLM 126a (e.g., via Copilot) to transform the plan into a diagram. This prompt can be entered by a user, or coded as a “canned prompt” for the user to select (e.g . . . “Create a Flowchart” among the prompt suggestions in FIG. 3D). Gauging the connections between the plan buckets and tasks, Copilot visualizes the same as a flowchart color coding the nodes that are complete (e.g., in green), work in progress (e.g., in yellow), and not started/at risk (e.g., in red). Copilot also suggests which nodes/tasks to take up next based on task dependence, priority, and/or estimated effort to quickly gauge on plan status and find next steps.

TABLE 10

Visualize the content in the Planner plan titled “Name of the plan”
in the form of a flowchart with each action item representing a
flowchart node. Infer the connections between nodes through task
dependencies & color code the nodes based on task priority
inferred using task assignee, due date, current status &
indicated importance.

In yet another scenario, the AI-based content transformation into diagram pipeline 200 creates a diagram for tabular items in an email application (e.g., Outlook) using the prompt in Table 11. This prompt can be entered by a user, or coded as a “canned prompt” for the user to select e.g . . . “Generate a SWOT Analysis” among the prompt suggestions in FIG. 3D. A SWOT analysis identifies internal and external factors that can impact the success of a company, project, or person, using four categories Strengths, Weaknesses, Opportunities, and Threats.

TABLE 11

Visualize the proposal in the tabular items in the Outlook mail
titled “Name of the mail” in the form of a SWOT analysis diagram.
Adjust the color & size of the nodes per inferred importance based
on frequency, content tonality, row positioning in table (with
higher rows having higher priority), feedback received & the
seniority of the person providing feedback.

The data pre-processing unit 128 may reformat or otherwise standardize the information to be included in the prompt to a standardized format that is recognized by the generative models 126. For instance, the content to be semantically analyzed may be in a non-digital format (e.g., a paper report). The generative models 126 are trained using training data in this standardized format, in some implementations, and utilizing this format for the prompts provided to the generative models 126 may improve the predictions provided by the generative models 126.

In some implementations, when the content of interest is already in the format directly processible by the generative models 126, the data pre-processing unit 128 does not need to convert the content of interest. In other implementations, when the content of interest is not in the format directly processible by the generative models 126, the data pre-processing unit 128 converts the content of interest to the format directly processible by the generative models 126. Some common standardized formats recognized by a language model include plain text, Markdown, HTML, JSON, XML, and the like. In one embodiment, the system converts content data into JSON, which is a lightweight and efficient data-interchange format. In addition, ChatML document format is used to provide document context information to ChatGPT, and ChatML may be used which is a JSON-based format that allows a user to specify the conversational history, dialog state, and other contextual information.

The prompt construction unit 124 then constructs a system prompt based on the content data and/or the meta prompt, and outputs the system prompt to the language model 126a to process different data type components 202a, 202b, 202c of the content of interest. In response to a diagram of content requested by a user, the system can fetch content data uploaded from one or more of the following (but not limited to) a virtual meeting and collaboration application (e.g., Microsoft Teams®), digital whiteboard application(s) (e.g., Microsoft Whiteboard®), employee experience application(s) (e.g., Microsoft Viva®), online collaboration application(s) (e.g., Microsoft Loop®), calendar application(s) (e.g., Microsoft Outlook®), email application(s) (e.g., Microsoft Outlook® email), task management application(s) (e.g., Microsoft To Do®), and team-work planning application(s) (e.g., Microsoft Planner®), software development application(s) (e.g., Microsoft Azure®), enterprise accounting and sales application(s) (e.g., Microsoft Dynamic®, Salesforce®, or the like), social media application(s) (e.g., Facebook®, Google® Blogger®, or the like), an online encyclopedia and/or databases (e.g., Wikipedia®), and the like. In some implementations, the user can also customize content data sources according to the user's preference(s), work style(s), and the like. For example, while the prompt construction unit 124 constructs the system prompt, the system prompt can be adapted or extended based on different implementations.

In one embodiment, in response to the user prompt or a system call, either the prompt construction unit 124 or the generative models 126 retrieves content component data 202a-202e from the content of interest based on the meta prompt.

As mentioned, the LLM 126a utilizes contextual feature data 140 (especially the semantic text) to generate the diagram data. In addition, the LLM 126a utilizes the contextual feature data 140 (especially the semantic text) to rank and determines key words/phrases/sentences/audio sections/scenes. The contextual feature data 140 can include places, events, other relevant documents, a title of the content, a topic of the content, a time when the content was captured, a location where the content was captured, an event captured in the content, roles of participants captured in the content, relationship of the participants, styles, names, team data, employee location data, individual employee's work preferences, and/or collaboration data obtained via organizational graph data, telemetry data, and the like. In one embodiment, the system extracts the contextual feature data 140 from meta data of the content. In another embodiment, the system retrieves sensor data (e.g., the sensor data 116), from the client device (e.g., the client device 105), to determine the contextual feature data 140.

In some implementations, the prompt construction unit 124 may submit further prompts to re-generate a diagram of content(s) based on user feedback. The prompt construction unit 124 can store the contextual feature data 140 for the duration of the user session in which the user uses the native application 114 or the browser application 112. A technical benefit of this approach is that the contextual feature data 140 does not need to be retrieved each time that the user submits a natural language prompt to generate a diagram of content. The request processing unit 122 maintains user session information in a persistent memory of the application services platform 110 and retrieves the contextual feature data 140 from the user session information in response to each subsequent prompt submitted by the user. The request processing unit 122 then provides the newly received user prompt and the contextual feature data 140 to the prompt construction unit 124 to construct the prompt as discussed in the preceding examples.

All the above-discussed contextual feature data 140, content and content component data 142, request, prompts and responses 144, sound/visual analysis data 146, and diagram data 148 can be stored in the enterprise data storage 134. The enterprise data storage 134 can be physical and/or virtual, depending on the entity's needs and IT infrastructure. Examples of physical enterprise data storage systems include network-attached storage (NAS), storage area network (SAN), direct-attached storage (DAS), tape libraries, hybrid storage arrays, object storage, and the like. Examples of virtual enterprise data storage systems include virtual SAN (vSAN), software-defined storage (SDS), cloud storage, hyper-converged Infrastructure (HCl), network virtualization and software-defined networking (SDN), container storage, and the like.

Since the diagram creation involves use of a generative AI which utilizes user content such as user voice and videos, personal data privacy and data ownership guidelines are taken into consideration. There are security and privacy considerations and strategies for using open source generative models with enterprise data, such as data anonymization, isolating data, providing secure access, securing the model, using a secure environment, encryption, regular auditing, compliance with laws and regulations, data retention policies, performing privacy impact assessment, user education, performing regular updates, providing disaster recovery and backup, providing an incident response plan, third-party reviews, and the like. By following these security and privacy best practices, the example computing environment 100 can minimize the risks associated with using open source generative models while protecting enterprise data from unauthorized access or exposure.

In an example, the application services platform 110 can store enterprise data separately from generative model training data, to reduce the risk of unintentionally leaking sensitive information during model generation. The application services platform 110 can limit access to generative models and the enterprise data. The application services platform 110 can also implement proper access controls, strong authentication, and authorization mechanisms to ensure that only authorized personnel can interact with the selected model and the enterprise data.

The application services platform 110 can also run the generative models 126 in a secure computing environment. Moreover, the application services platform 110 can employ robust network security, firewalls, and intrusion detection systems to protect against external threats. The application services platform 110 can encrypt the enterprise data and any data in transit. The application services platform 110 can also employ encryption standards for data storage and data transmission to safeguard against data breaches.

Moreover, the application services platform 110 can implement strong security measures around the generative models 126, such as regular security audits, code reviews, and ensuring that the model is up-to-date with security patches. The application services platform 110 can periodically audit the generative model's usage and access logs, to detect any unauthorized or anomalous activities. The application services platform 110 can also ensure that any use of open source generative models complies with relevant data protection regulations such as GDPR, HIPAA, or other industry-specific compliance standards.

The application services platform 110 can establish data retention and data deletion policies to ensure that generated data is not stored longer than necessary, to minimizes the risk of data exposure. The application services platform 110 can perform a privacy impact assessment (PIA) to identify and mitigate potential privacy risks associated with the generative model's usage. The application services platform 110 can also provide mechanisms for training and educating users on the proper handling of enterprise data and the responsible use of generative models. In addition, the application services platform 110 can stay up-to-date with evolving security threats and best practices that are essential for ongoing data protection.

FIGS. 3A-3E are diagrams of an example user interface of an AI-based content generation application that implements the techniques described herein. The example user interface shown in FIGS. 3A-3E is a user interface of an AI-based content generation application, such as but not limited to Microsoft Copilot®. However, the techniques herein for providing AI-based content transformation into diagrams are not limited to use in the AI-based content generation application and may be used to generate diagrams of content for other types of applications including but not limited to presentation applications, website authoring applications, collaboration platforms, communications platforms, and/or other types of applications in which users create, view, and/or modify various types of diagrams of content. Such applications can be a stand-alone application, or a plug-in of any application on the client device 105, such as the browser application 112, the native application 114, and the like. For example, the system can work on the web or within a virtual meeting and collaboration application (e.g., MICROSOFT TEAMS®) or an email application (e.g., OUTLOOK®). The system can be integrated into the MICROSOFT VIVA® platform or could work within a browser (e.g., WINDOWS® EDGE®), or MICROSOFT COPILOT®. The system can also work within a website chat functionality (e.g., the BING® chat functionality).

FIG. 3A shows an example of the user interface 305 of an AI-based content generation application in which the user is interacting with an AI generative model to generate a diagram of content. The user interface 305 includes a control pane 315, a chat pane 325 and a scrollbar 335. The user interface 305 may be implemented by the native application 114 and/or the browser application 112.

In some implementations, the control pane 315 includes an AI-Assistant button 315a, an Upload button 315b, a Transform to Diagram button 315c, a Content Management button 315d, an Other Options button 315e, and a search field 315f. The AI-Assistant button 315a can be selected to provide content generation functions. In some implementations, the chat pane 325 provides a workspace in which the user can enter prompts in the AI-based content generation application. The chat pane 325 also includes a prompt enter box 325a enabling the user to enter a natural language prompt. In the example shown in FIG. 3A, the prompt enter box 325a shows “Ask me anything.”

User prompts usually describe content that the user would like to have automatically generated by the generative models 126 of the application services platform 110. The application submits the natural language prompt to the application services platform 110 and user information identifying the user of the application to the application services platform 110. The application services platform 110 processes the request according to the techniques provided herein to generate content and/or a diagram of the content according to the user prompt.

In FIG. 3A, since there is no content in the chat pane 325, the user selects the Transform to Diagram button 315c to call a popup screen 325b to transfer content from a link, or to call a popup screen 325c to transfer content from a file. The popup screen 325b shows a prompt enter box. In response to the user entry of “Transfer content from this link”, the popup screen 325b shows an Insert Link icon for the user to select and an Insert Link field for the user to enter the link, as well as automatically suggest additional words “into a mind map and expand each idea. Go 4 level deep” to finish the user prompt in the prompt enter box. For instance, the LLM 126a generates the prompt suggestions based on group or individual user usage history and/or preference data. The popup screen 325b further shows a View Prompts button for view prompts (e.g., in a chronological order, per user, per topic/subject, or the like), a Diagram button for selecting a diagram type, and a Preview button for preview a diagram generated based on a selected diagram type (e.g., as specified in the prompt enter box 325a or the prompt enter box in the popup screen 325b, or selected via the Diagram button).

The popup screen 325c also shows a prompt enter box. In response to the user entry of “Transfer content from this file”, the popup screen 325c shows an Attach File icon for the user to select and an Attach File field for the user to enter the location of the file, as well as automatically suggest additional words “into a mind map and expand each idea. Go 4 level deep” to finish the user prompt in the prompt enter box. For instance, the LLM 126a generates the prompt suggestions based on group or individual user usage history and/or preference data. In response to the user entry of “Transfer content from this file” in the prompt enter box, the popup screen 325c further shows an option of “Upload form this device”. Upon a user selection of the option of “Upload form this device,” the popup screen 325c shows some suggested files for upload. The suggested files may be what the user recently worked on, or suggestions based on group or individual user usage history and/or preference data. The popup screen 325c also shows a View Prompts button, a Diagram button and a Preview button as those in the popup screen 325b.

Alternatively, since there is no content in the chat pane 325, the user can select the Upload button 315b to upload content to be semantically analyzed for generating a diagram. The user can upload text/audio/video/other files from one or more of the applications to generate one diagram. In this example, the UI 305 in FIG. 3B shows an application pane 345 with an opened digital whiteboard application (e.g., Whiteboard®) file, or an active digital whiteboard application session.

FIG. 3B depicts a vote on top idea session in the application pane 345 with three voting items: User Experience, Increase Revenue, or the like. Upon a user selection of the Transform to Diagram button 315c, a popup screen 345a is shown in FIG. 3B. Based on the context, the system reasons that the user intents to transfer the content in the application pane 345 into a visual, and automatically suggests a prompt of “Transform board content into a mind map and expand each idea. Go 4 level deep” and an Enter icon in the prompt enter box for the user to select.

Alternatively, the user can trigger the generation of a diagram using a View Prompts button, a Diagram button and a Preview button as those in the popup screen 345a. For instance, the user selects an output format (e.g., Diagram) from a dropdown output format menu 345b shown in FIG. 3C. The dropdown output format menu 345b includes options of: Notes, Loop, Diagram, and Template. The popup screen 345a then shows a dropdown prompt suggestions menu 345c in FIG. 3D, after selecting the Diagram option in the dropdown output format menu 345b, thereby adding/incorporating suggested prompt into the prompt in the prompt enter box of the popup screen 345a. The dropdown prompt suggestions menu 345c includes options of Expend Ideas, Extract Action Items, Find Pros and Cons, Decision Making Flowchart, Generate a SWOT Analysis, and Summarize Ideas.

The user can then preview the draft mind map generated with the prompt addition (e.g., Expend Ideas) in FIG. 3E as in the above-discussed embodiment. In this case, Expend Ideas was already suggested by the LLM 126a. FIG. 3E shows a diagram pane 355 with a mind map 355a of a Whiteboard® enhancement plan (e.g., for the Microsoft Whiteboard product managers scenario). In addition, FIG. 3E shows a Level of Detail popup screen 355b including three levels for a user to select: Basic, Moderate, Detailed.

By analogy, the diagram pane can show a mind map of a Microsoft Teams® updates (e.g., for the Microsoft Whiteboard product managers scenario) similar to the mind map 355a in FIG. 3E, in response to the user entry of “Transfer content from this link Teams® Update into a mind map and expand each idea. Go 4 level deep”.

In some implementations, the system provides a feedback loop by augmenting thumbs up and thumbs down buttons for each diagram in the user interface 305. If the user dislikes a diagram, the system can ask why and use the input to improve the diagram. A thumbs down click could also prompt the user to indicate whether the diagram was too big, too small, missing information, and the like.

The user prompts, the content, and the user feedback are submitted to the application services platform 110 to re-generate a diagram using the generative models 126 and/or to improve the generative models 126. The AI-based content transformation into diagram pipeline 200 thus incorporates user feedback in real-time or in substantially real-time, and allows user edits via intuitive user interfaces.

In some implementations, the application services platform 110 includes a moderation services that analyze user prompt(s), user feedbacks, and diagrams generated by the generative models 126, to ensure that potentially objectionable or offensive content is not generated or utilized by the application services platform 110.

If potentially objectionable or offensive content is detected in the user prompt(s), the user feedbacks, and the diagrams, the moderation services provides a blocked content notification to the client device 105 indicating that the prompt(s), the user data is blocked from forming the system prompt. In some implementations, the request processing unit 122 discards any user data that includes potentially objectionable or offensive content and passes any remaining content that has not been discarded to the request processing unit 122 to be provided as an input to the prompt construction unit 124. In other implementations, the prompt construction unit 124 discards any content that includes potentially objectionable or offensive content and passes any remaining content that has not been discarded to the generative models 126 as an input.

In one embodiment, the prompt construction unit 124 submits the user prompt(s), and/or the system prompt to the moderation services to ensure that the prompt does not include any potentially objectionable or offensive content. The prompt construction unit 124 halts the processing of the user prompt(s), and/or the system prompt in response to the moderation services determining that the user prompt(s) and/or the diagram of content data includes potentially objectionable or offensive content. As discussed in the preceding examples, the moderation services generates a blocked content notification in response to determining that the user prompt(s), and/or the system prompt includes potentially objectionable or offensive content, and the notification is provided to the native application 114 or the browser application 112 so that the notification can be presented to the user on the client device 105. For instance, the user may attempt to revise and resubmit the user prompt(s). As another example, the system may generate another system prompt after removing task data associated with the potentially objectionable or offensive content.

The moderation services can be implemented by a machine learning model trained to analyze the content of these various inputs and/or outputs to perform a semantic analysis on the content to predict whether the content includes potentially objectionable or offensive content. The moderation services can perform another check on the content using a machine learning model configured to analyze the words and/or phrase used in content to identify potentially offensive language/image/sound. The moderation services can compare the language used in the content with a list of prohibited terms/images/sounds including known offensive words and/or phrases, images, sounds, and the like. The moderation services can provide a dynamic list that can be quickly updated by administrators to add additional prohibited terms/images/sounds. The dynamic list may be updated to address problems such as words or phrases becoming offensive that were not previously deemed to be offensive. The words and/or phrases added to the dynamic list may be periodically migrated to the guard list as the guard list is updated. The specific checks performed by the moderation services may vary from implementation to implementation. If one or more of these checks determines that the textual content includes offensive content, the moderation services can notify the application services platform 110 that some action should be taken.

In some implementations, the moderation services generates a blocked content notification, which is provided to the client device 105. The native application 114 or the browser application 112 receives the notification and presents a message on a user interface of the application that the user prompt received by the request processing unit 122 could not be processed. The user interface provides information indicating why the blocked content notification was issued in some implementations. The user may attempt to refine a natural language prompt to remove the potentially offensive content. A technical benefit of this approach is that the moderation services provides safeguards against both user-created and model-created content to ensure that prohibited offensive or potentially offensive content is not presented to the user in the native application 114 or the browser application 112.

As mentioned, the application services platform 110 complies with privacy guidelines and regulations that apply to the usage of user data included in the content to be semantically analyzed to ensure that users have control over how the application services platform 110 utilizes their data. The user is provided with an opportunity to opt into the application services platform 110 to allow the application services platform 110 to access the user data and enable the generative models 126 to generate a diagram of the content according to user consent. In some implementations, the first time that an application, such as the native application 114 or the browser application 112 presents the data analysis assistant to the user, the user is presented with a message that indicates that the user may opt into allowing the application services platform 110 to use user data included in the content to support the diagram functionality. The user may opt into allowing the application services platform 110 to access all or a subset of user data included in the content to be semantically analyzed in a video. Furthermore, the user may modify their opt-in status at any time by selectively opting into or opting out of allowing the application services platform 110 from accessing and utilizing user data from the content as a whole or individually.

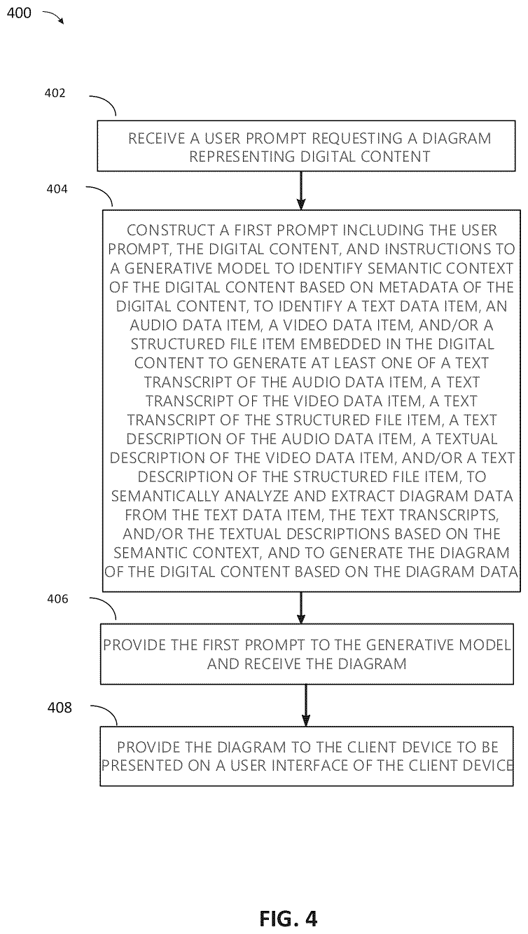

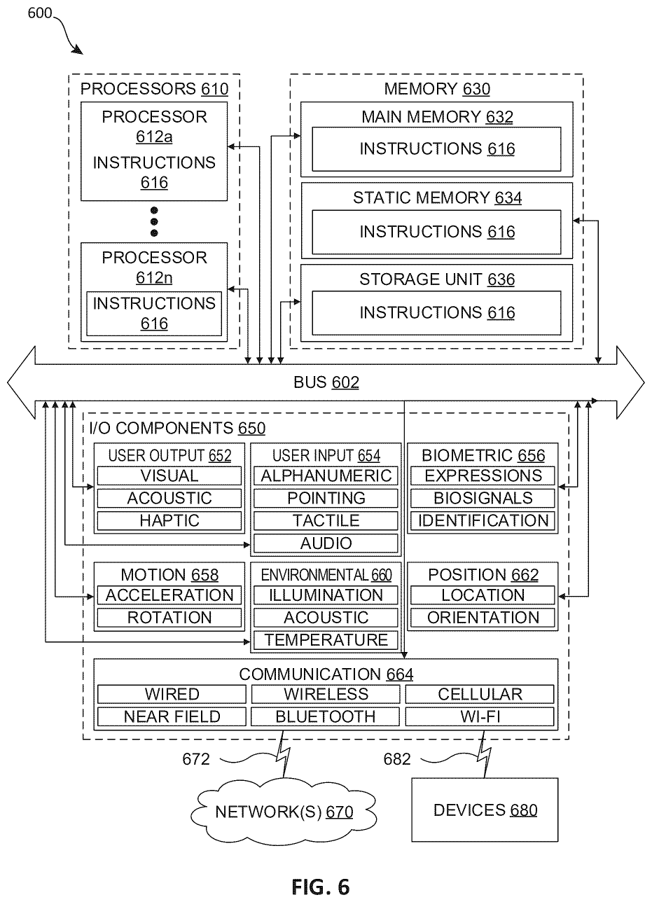

FIG. 4 is a flow chart of an example process for AI-based diagram creation according to the techniques disclosed herein. The process 400 can be implemented by the application services platform 110 or its components shown in the preceding examples. The process 400 may be implemented in, for instance, the example machine including a processor and a memory as shown in FIG. 6. As such, the application services platform 110 can provide means for accomplishing various parts of the process 400, as well as means for accomplishing embodiments of other processes described herein in conjunction with other components of the example computing environment 100. Although the process 400 is illustrated and described as a sequence of steps, it is contemplated that various embodiments of the process 400 may be performed in any order or combination and need not include all the illustrated steps.

In one embodiment, for example, in step 402, a request processing unit (e.g., the request processing unit 122) receives, via a client device (e.g., the client device 105) a user prompt requesting a diagram (e.g., the draft diagram 214 or the final diagram 216 in FIG. 2B, or the mind map 355a in FIG. 3E) representing digital content (e.g., the content of interest in FIG. 2A). The digital content includes any of text, audio, video, or structured file. In some implementations, the digital content and the call are received via a software application, and the software application is a virtual meeting and collaboration application (e.g., Microsoft Teams®), a digital whiteboard application (e.g., Microsoft Whiteboard®), an employee experience application (e.g., Microsoft Viva®), an online collaboration application (e.g., Microsoft Loop®), a calendar application (e.g., Microsoft Outlook®), an email application (e.g., Microsoft Outlook® email), a task management application (e.g., Microsoft To Do®), a team-work planning application (e.g., Microsoft Planner®), a software development application (e.g., Microsoft Azure®), an enterprise accounting and sales application (e.g., Microsoft Dynamic®), a social media application (e.g., Facebook®), or an online encyclopedia and/or database (e.g., Wikipedia®).

In step 404, a prompt construction unit (e.g., the prompt construction unit 124) constructs a first prompt by appending the user prompt and the digital content to a first instruction string, the first instruction string including instructions to a generative model (e.g., the LMM 126b) to identify semantic context (e.g., the semantic context) of the digital content based on metadata of the digital content, to identify at least one of a text data item (e.g., the text content 202a, such as an industrial magazine article), an audio data item (e.g., the audio content 202c, such as an audio recording), a video data item (e.g., the video content 202d, such as digital whiteboard images of financial PowerPoint slides, and marketing videos), or a structured file item (e.g., the structured file content 202e, such as Whiteboard notes), embedded in the digital content to generate at least one of a text transcript of the audio data item, a text transcript of the video data item, a text transcript of the structured file item, a text description of the audio data item, a textual description of the video data item, or a text description of the structured file item, to semantically analyze and extract diagram data from at least one of the text data item, the text transcripts, or the textual descriptions based on the semantic context (e.g., people, places, events, other relevant attributes), and to generate the diagram of the digital content based on the diagram data.

In one embodiment, the first instruction string further includes instructions to determine a diagram type of the diagram based on at least one of the semantic context, the diagram data, a user intent, or a level of detail, and the diagram type is a timeline, flowchart, decision tree, mind map, organization chart, fishbone, bar chart, scatter plot, pie chart, histogram, or heat map. In another embodiment, the first instruction string further includes instructions to extract the user intent or the level of detail from the user prompt, or to infer the user intent or the level of detail from at least one of the semantic context or the diagram data. In yet another embodiment, the first instruction string further includes instructions to iteratively extract the diagram data from the at least one of the text data item, the text transcripts, or the textual descriptions based on the semantic context and the user intent, and to generate the diagram of the digital content based on the diagram data and the user intent, until the diagram meets a threshold of representing the user intent.

In an example, the semantic context of the digital content includes at least one of a title of the digital content, a topic of the digital content, a time when the digital content was captured, a location where the digital content was captured, an event captured in the digital content, roles of participants captured in the digital content, or relationship of the participants. In one embodiment, the generative model is a multimodal model (e.g., the LMM 126b) that handle all of the instructions in the first instruction string. In another embodiment, the LLM 126a handles most of the instructions in the first instruction string except for generating the diagram that is left for the LVM 126c (e.g., Dalle-E, Sora, or the like) to handle.

In some implementations, the user prompt is a predetermined prompt selected at the client device for the digital content. For instance, the predetermined prompt is expending ideas, extracting action items, finding pros and cons, generating a decision making flowchart, generating a SWOT analysis, or summarizing ideas.

In one embedment, the first instruction string includes instructions to the generative model to analyze one or more speeches of the audio data item or the video data item for one or more talking points, and to semantically analyze the audio data item or the video data item further based on the one or more talking points. In another embedment, to analyze the one or more speeches includes analyzing at least one of tone, intonation, pitch, volume, and speaking rate of the one or more speeches (which can be extracted via the sound/speech analysis and required a specially trained LMM to process).

In one embedment, the first instruction string includes instructions to the generative model to analyze one or more scenes in the video data item, and to include the one or more scenes in the diagram of the digital content. In another embedment, to analyze the one or more scenes includes to analyze at least one of color, motion, object, participant change among the one or more scenes (which can be extracted via the visual analysis and required a specially trained LMM to process).

In step 406, the prompt construction unit provides as an input the first prompt to the generative model and receiving as an output the diagram from the generative model.

In step 408, the request processing unit provides the diagram to the client device to be presented on a user interface (e.g., the user interface 305 in FIGS. 3A-3E) of the client device.

In one embodiment, the request processing unit receives at least one user feedback on the diagram via the user interface of the client device. For instance, the user feedback is collected via a user selection of at least one of a thumbs-up tab, a thumbs-down tab, a neutral tab, or a generating-more-image tab, a textual input, or a combination thereof. The prompt construction unit constructs a second prompt by appending the feedback and the diagram to a second instruction string, the second instruction string including instructions to the generative model to generate at least another diagram based on the feedback and the diagram, by adjusting one or more attributes of the diagram based on the feedback. The prompt construction unit provides as an input the second prompt to the generative model and receives as an output the other diagram of the digital content from the generative model. The request processing unit provides the other diagram to the client device, and causes the user interface of the client device to present the other diagram.

In another embodiment, the request processing unit causes the user interface to receive a confirmation of the diagram from a user, and causes a publication of the diagram. In some implementations, the request processing unit works in conjunction with the editing unit 130 to cause the user interface to receive a comment or annotation from a user to edit the diagram, or causes the user interface to present interactive elements for the user to edit the diagram. For instance, the editing unit 130 works in conjunction with the request processing unit 122 to interact with users through a graphical user interface (GUI), providing a visual workspace for manipulating the diagram.

Therefore, the system can assist users to generate a diagram of content, via a chat interface. Such visual diagram of content can help a user to quickly understand the content. In particular, the system supports generating effective system prompts with extracted text data from different content components, and such system prompts are clear, concise, and provide enough context for the generative models to generate the diagram of content. In addition, the system provides users interactive tools to change/refine the diagram of content, and then share/publish the diagram of content.

For example, the system uses generative AI to create a daily diagram of content for an individual. Each task is assigned a discrete timeslot and includes a set of inferred actions that provide context and relevant documentation to help the user perform the task. The user can use the AI-based content generation application at the start of a day and view a diagram of content of tasks and suggested actions to complete each task. In this way, the user no longer needs to look through the disparate task sources and work out how to divide the time among the tasks.

The detailed examples of systems, devices, and techniques described in connection with FIGS. 1-4 are presented herein for illustration of the disclosure and its benefits. Such examples of use should not be construed to be limitations on the logical process embodiments of the disclosure, nor should variations of user interface methods from those described herein be considered outside the scope of the present disclosure. It is understood that references to displaying or presenting an item (such as, but not limited to, presenting an image on a display device, presenting audio via one or more loudspeakers, and/or vibrating a device) include issuing instructions, commands, and/or signals causing, or reasonably expected to cause, a device or system to display or present the item. In some embodiments, various features described in FIGS. 1-4 are implemented in respective modules, which may also be referred to as, and/or include, logic, components, units, and/or mechanisms. Modules may constitute either software modules (for example, code embodied on a machine-readable medium) or hardware modules.

In some examples, a hardware module may be implemented mechanically, electronically, or with any suitable combination thereof. For example, a hardware module may include dedicated circuitry or logic that is configured to perform certain operations. For example, a hardware module may include a special-purpose processor, such as a field-programmable gate array (FPGA) or an Application Specific Integrated Circuit (ASIC). A hardware module may also include programmable logic or circuitry that is temporarily configured by software to perform certain operations and may include a portion of machine-readable medium data and/or instructions for such configuration. For example, a hardware module may include software encompassed within a programmable processor configured to execute a set of software instructions. It will be appreciated that the decision to implement a hardware module mechanically, in dedicated and permanently configured circuitry, or in temporarily configured circuitry (for example, configured by software) may be driven by cost, time, support, and engineering considerations.

Accordingly, the phrase “hardware module” should be understood to encompass a tangible entity capable of performing certain operations and may be configured or arranged in a certain physical manner, be that an entity that is physically constructed, permanently configured (for example, hardwired), and/or temporarily configured (for example, programmed) to operate in a certain manner or to perform certain operations described herein. As used herein, “hardware-implemented module” refers to a hardware module. Considering examples in which hardware modules are temporarily configured (for example, programmed), each of the hardware modules need not be configured or instantiated at any one instance in time. For example, where a hardware module includes a programmable processor configured by software to become a special-purpose processor, the programmable processor may be configured as respectively different special-purpose processors (for example, including different hardware modules) at different times. Software may accordingly configure a processor or processors, for example, to constitute a particular hardware module at one instance of time and to constitute a different hardware module at a different instance of time. A hardware module implemented using one or more processors may be referred to as being “processor implemented” or “computer implemented.”

Hardware modules can provide information to, and receive information from, other hardware modules. Accordingly, the described hardware modules may be regarded as being communicatively coupled. Where multiple hardware modules exist contemporaneously, communications may be achieved through signal transmission (for example, over appropriate circuits and buses) between or among two or more of the hardware modules. In embodiments in which multiple hardware modules are configured or instantiated at different times, communications between such hardware modules may be achieved, for example, through the storage and retrieval of information in memory devices to which the multiple hardware modules have access. For example, one hardware module may perform an operation and store the output in a memory device, and another hardware module may then access the memory device to retrieve and process the stored output.

In some examples, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by, and/or among, multiple computers (as examples of machines including processors), with these operations being accessible via a network (for example, the Internet) and/or via one or more software interfaces (for example, an application program interface (API)). The performance of certain of the operations may be distributed among the processors, not only residing within a single machine, but deployed across several machines. Processors or processor-implemented modules may be in a single geographic location (for example, within a home or office environment, or a server farm), or may be distributed across multiple geographic locations.

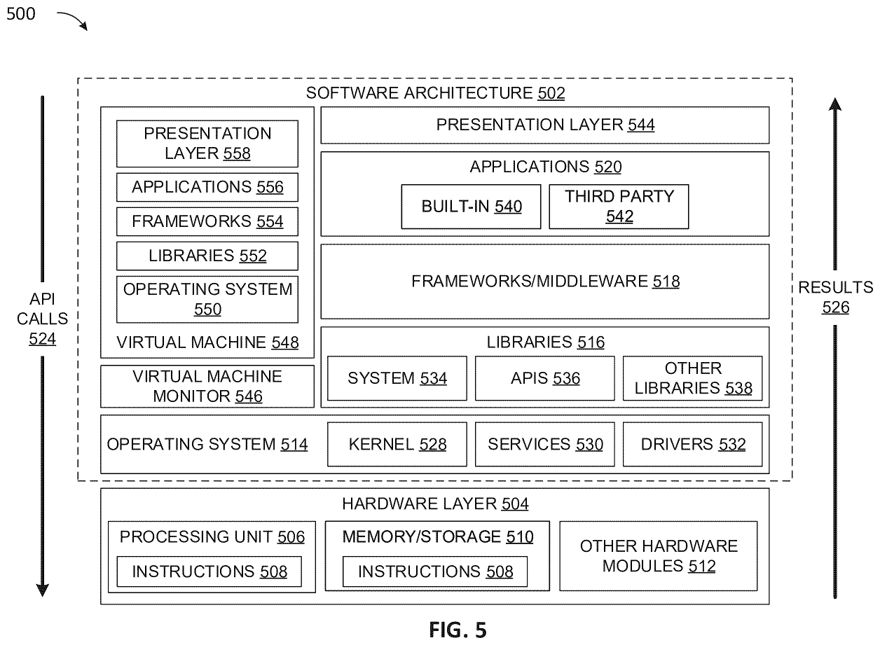

FIG. 5 is a block diagram 500 illustrating an example software architecture 502, various portions of which may be used in conjunction with various hardware architectures herein described, which may implement any of the above-described features. FIG. 5 is a non-limiting example of a software architecture, and it will be appreciated that many other architectures may be implemented to facilitate the functionality described herein. The software architecture 502 may execute on hardware such as a machine 600 of FIG. 6 that includes, among other things, processors 610, memory 630, and input/output (I/O) components 650. A representative hardware layer 504 is illustrated and can represent, for example, the machine 600 of FIG. 6. The representative hardware layer 504 includes a processing unit 506 and associated executable instructions 508. The executable instructions 508 represent executable instructions of the software architecture 502, including implementation of the methods, modules and so forth described herein. The hardware layer 504 also includes a memory/storage 510, which also includes the executable instructions 508 and accompanying data. The hardware layer 504 may also include other hardware modules 512. Instructions 508 held by processing unit 506 may be portions of instructions 508 held by the memory/storage 510.

The example software architecture 502 may be conceptualized as layers, each providing various functionality. For example, the software architecture 502 may include layers and components such as an operating system (OS) 514, libraries 516, frameworks 518, applications 520, and a presentation layer 544. Operationally, the applications 520 and/or other components within the layers may invoke API calls 524 to other layers and receive corresponding results 526. The layers illustrated are representative in nature and other software architectures may include additional or different layers. For example, some mobile or special purpose operating systems may not provide the frameworks/middleware 518.

The OS 514 may manage hardware resources and provide common services. The OS 514 may include, for example, a kernel 528, services 530, and drivers 532. The kernel 528 may act as an abstraction layer between the hardware layer 504 and other software layers. For example, the kernel 528 may be responsible for memory management, processor management (for example, scheduling), component management, networking, security settings, and so on. The services 530 may provide other common services for the other software layers. The drivers 532 may be responsible for controlling or interfacing with the underlying hardware layer 504. For instance, the drivers 532 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 516 may provide a common infrastructure that may be used by the applications 520 and/or other components and/or layers. The libraries 516 typically provide functionality for use by other software modules to perform tasks, rather than interacting directly with the OS 514. The libraries 516 may include system libraries 534 (for example, C standard library) that may provide functions such as memory allocation, string manipulation, file operations. In addition, the libraries 516 may include API libraries 536 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 516 may also include a wide variety of other libraries 538 to provide many functions for applications 520 and other software modules.

The frameworks 518 (also sometimes referred to as middleware) provide a higher-level common infrastructure that may be used by the applications 520 and/or other software modules. For example, the frameworks 518 may provide various graphic user interface (GUI) functions, high-level resource management, or high-level location services. The frameworks 518 may provide a broad spectrum of other APIs for applications 520 and/or other software modules.

The applications 520 include built-in applications 540 and/or third-party applications 542. Examples of built-in applications 540 may include, but are not limited to, a contacts application, a browser application, a location application, a media application, a messaging application, and/or a game application. Third-party applications 542 may include any applications developed by an entity other than the vendor of the particular platform. The applications 520 may use functions available via OS 514, libraries 516, frameworks 518, and presentation layer 544 to create user interfaces to interact with users.

Some software architectures use virtual machines, as illustrated by a virtual machine 548. The virtual machine 548 provides an execution environment where applications/modules can execute as if they were executing on a hardware machine (such as the machine 600 of FIG. 6, for example). The virtual machine 548 may be hosted by a host OS (for example, OS 514) or hypervisor, and may have a virtual machine monitor 546 which manages operation of the virtual machine 548 and interoperation with the host operating system. A software architecture, which may be different from software architecture 502 outside of the virtual machine, executes within the virtual machine 548 such as an OS 550, libraries 552, frameworks 554, applications 556, and/or a presentation layer 558.

FIG. 6 is a block diagram illustrating components of an example machine 600 configured to read instructions from a machine-readable medium (for example, a machine-readable storage medium) and perform any of the features described herein. The example machine 600 is in a form of a computer system, within which instructions 616 (for example, in the form of software components) for causing the machine 600 to perform any of the features described herein may be executed. As such, the instructions 616 may be used to implement modules or components described herein. The instructions 616 cause unprogrammed and/or unconfigured machine 600 to operate as a particular machine configured to carry out the described features. The machine 600 may be configured to operate as a standalone device or may be coupled (for example, networked) to other machines. In a networked deployment, the machine 600 may operate in the capacity of a server machine or a client machine in a server-client network environment, or as a node in a peer-to-peer or distributed network environment. Machine 600 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 600 is illustrated, the term “machine” includes a collection of machines that individually or jointly execute the instructions 616.

The machine 600 may include processors 610, memory 630, and I/O components 650, which may be communicatively coupled via, for example, a bus 602. The bus 602 may include multiple buses coupling various elements of machine 600 via various bus technologies and protocols. In an example, the processors 610 (including, for example, a central processing unit (CPU), a graphics processing unit (GPU), a neural processing unit (NPU), a digital signal processor (DSP), an ASIC, or a suitable combination thereof) may include one or more processors 612a to 612n that may execute the instructions 616 and process data. In some examples, one or more processors 610 may execute instructions provided or identified by one or more other processors 610. The term “processor” includes a multi-core processor including cores that may execute instructions contemporaneously. Although FIG. 6 shows multiple processors, the machine 600 may include a single processor with a single core, a single processor with multiple cores (for example, a multi-core processor), multiple processors each with a single core, multiple processors each with multiple cores, or any combination thereof. In some examples, the machine 600 may include multiple processors distributed among multiple machines.

The memory/storage 630 may include a main memory 632, a static memory 634, or other memory, and a storage unit 636, both accessible to the processors 610 such as via the bus 602. The storage unit 636 and memory 632, 634 store instructions 616 embodying any one or more of the functions described herein. The memory/storage 630 may also store temporary, intermediate, and/or long-term data for processors 610. The instructions 616 may also reside, completely or partially, within the memory 632, 634, within the storage unit 636, within at least one of the processors 610 (for example, within a command buffer or cache memory), within memory at least one of I/O components 650, or any suitable combination thereof, during execution thereof. Accordingly, the memory 632, 634, the storage unit 636, memory in processors 610, and memory in I/O components 650 are examples of machine-readable media.

As used herein, “machine-readable medium” refers to a device able to temporarily or permanently store instructions and data that cause machine 600 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 616) for execution by a machine 600 such that the instructions, when executed by one or more processors 610 of the machine 600, cause the machine 600 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 650 may include a wide variety of hardware components adapted to receive input, provide output, produce output, transmit information, exchange information, capture measurements, and so on. The specific I/O components 650 included in a particular machine will depend on the type and/or function of the machine. For example, mobile devices such as mobile phones may include a touch input device, whereas a headless server or IoT device may not include such a touch input device. The particular examples of I/O components illustrated in FIG. 6 are in no way limiting, and other types of components may be included in machine 600. The grouping of I/O components 650 are merely for simplifying this discussion, and the grouping is in no way limiting. In various examples, the I/O components 650 may include user output components 652 and user input components 654. User output components 652 may include, for example, display components for displaying information (for example, a liquid crystal display (LCD) or a projector), acoustic components (for example, speakers), haptic components (for example, a vibratory motor or force-feedback device), and/or other signal generators. User input components 654 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 650 may include biometric components 656, motion components 658, environmental components 660, and/or position components 662, among a wide array of other physical sensor components. The biometric components 656 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 658 may include, for example, acceleration sensors (for example, an accelerometer) and rotation sensors (for example, a gyroscope). The environmental components 660 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 662 may include, for example, location sensors (for example, a Global Position System (GPS) receiver), altitude sensors (for example, an air pressure sensor from which altitude may be derived), and/or orientation sensors (for example, magnetometers).

The I/O components 650 may include communication components 664, implementing a wide variety of technologies operable to couple the machine 600 to network(s) 670 and/or device(s) 680 via respective communicative couplings 672 and 682. The communication components 664 may include one or more network interface components or other suitable devices to interface with the network(s) 670. The communication components 664 may include, for example, components adapted to provide wired communication, wireless communication, cellular communication, Near Field Communication (NFC), Bluetooth communication, Wi-Fi, and/or communication via other modalities. The device(s) 680 may include other machines or various peripheral devices (for example, coupled via USB).

In some examples, the communication components 664 may detect identifiers or include components adapted to detect identifiers. For example, the communication components 664 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 664, such as, but not limited to, geo-location via Internet Protocol (IP) address, location via Wi-Fi, cellular, NFC, Bluetooth, or other wireless station identification and/or signal triangulation.

In the preceding detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element. Furthermore, subsequent limitations referring back to “said element” or “the element” performing certain functions signifies that “said element” or “the element” alone or in combination with additional identical elements in the process, method, article, or apparatus are capable of performing all of the recited functions.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system comprising:
a processor; and
a machine-readable storage medium storing executable instructions that, when executed, cause the processor alone or in combination with other processors to perform operations of:
receiving, via a client device, a user prompt requesting a diagram representing digital content, wherein the digital content includes any of text, audio, video, or structured file;
constructing, via a prompt construction unit, a first prompt by appending the user prompt and the digital content to a first instruction string, the first instruction string including instructions to a generative model to identify semantic context of the digital content based on metadata of the digital content, to identify at least one of a text data item, an audio data item, a video data item, or a structured file item, embedded in the digital content to generate at least one of a text transcript of the audio data item, a text transcript of the video data item, a text transcript of the structured file item, a text description of the audio data item, a textual description of the video data item, or a text description of the structured file item, to semantically analyze and extract diagram data from at least one of the text data item, the text transcripts, or the textual descriptions based on the semantic context, and to generate the diagram of the digital content based on the diagram data;
providing, via the prompt construction unit, as an input the first prompt to the generative model and receiving as an output the diagram from the generative model; and
providing the diagram to the client device to be presented on a user interface of the client device.

2. The data processing system of claim 1, wherein the first instruction string further includes instructions to determine a diagram type of the diagram based on at least one of the semantic context, the diagram data, a user intent, or a level of detail, and
wherein the diagram type is a timeline, flowchart, decision tree, mind map, organization chart, fishbone, bar chart, scatter plot, pie chart, histogram, or heat map.

3. The data processing system of claim 2, wherein the first instruction string further includes instructions to extract the user intent or the level of detail from the user prompt, or to infer the user intent or the level of detail from at least one of the semantic context or the diagram data.

4. The data processing system of claim 2, wherein the first instruction string further includes instructions to iteratively extract the diagram data from the at least one of the text data item, the text transcripts, or the textual descriptions based on the semantic context and the user intent, and to generate the diagram of the digital content based on the diagram data and the user intent, until the diagram meets a threshold of representing the user intent.

5. The data processing system of claim 1, wherein the user prompt is a predetermined prompt selected at the client device for the digital content.

6. The data processing system of claim 1, wherein the predetermined prompt is expending ideas, extracting action items, finding pros and cons, generating a decision making flowchart, generating a SWOT analysis, or summarizing ideas.

7. The data processing system of claim 1, wherein the machine-readable storage medium further includes instructions configured to cause the processor alone or in combination with other processors to perform operations of:
receiving at least one user feedback on the diagram via the user interface of the client device.

8. The data processing system of claim 7, wherein the machine-readable storage medium further includes instructions configured to cause the processor alone or in combination with other processors to perform operations of:
constructing, via the prompt construction unit, a second prompt by appending the feedback and the diagram to a second instruction string, the second instruction string including instructions to the generative model to generate at least another diagram based on the feedback and the diagram, by adjusting one or more attributes of the diagram based on the feedback;
providing, via the prompt construction unit, as an input the second prompt to the generative model and receiving as an output the other diagram of the digital content from the generative model; and
providing the other diagram to the client device to be presented on the user interface of the client device.

9. The data processing system of claim 7, wherein the user feedback is collected via a user selection of at least one of a thumbs-up tab, a thumbs-down tab, a neutral tab, or a generating-more-image tab, a textual input, or a combination thereof.

10. The data processing system of claim 1, wherein the machine-readable storage medium further includes instructions configured to cause the processor alone or in combination with other processors to perform operations of:
causing the user interface to receive a user confirmation of the diagram; and
causing a publication of the diagram.

11. The data processing system of claim 1, wherein the generative model is a language model or a multimodal model.

12. The data processing system of claim 1, wherein the digital content and the user prompt are received via a software application, and wherein the software application is a virtual meeting and collaboration application, a digital whiteboard application, an employee experience application, an online collaboration application, a calendar application, an email application, a task management application, a team-work planning application, a software development application, an enterprise accounting and sales application, a social media application, or an online encyclopedia.

13. A method comprising:
receiving, via a client device, a user prompt requesting a diagram representing digital content, wherein the digital content includes any of text, audio, video, or structured file;
constructing, via a prompt construction unit, a first prompt by appending the user prompt and the digital content to a first instruction string, the first instruction string including instructions to a generative model to identify semantic context of the digital content based on metadata of the digital content, to identify at least one of a text data item, an audio data item, a video data item, or a structured file item, embedded in the digital content to generate at least one of a text transcript of the audio data item, a text transcript of the video data item, a text transcript of the structured file item, a text description of the audio data item, a textual description of the video data item, or a text description of the structured file item, to semantically analyze and extract diagram data from at least one of the text data item, the text transcripts, or the textual descriptions based on the semantic context, and to generate the diagram of the digital content based on the diagram data;
providing, via the prompt construction unit, as an input the first prompt to the generative model and receiving as an output the diagram from the generative model; and
providing the diagram to the client device to be presented on a user interface of the client device.

14. The method of claim 13, wherein the first instruction string further includes instructions to determine a diagram type of the diagram based on at least one of the semantic context, the diagram data, a user intent, or a level of detail, and
wherein the diagram type is a timeline, flowchart, decision tree, mind map, organization chart, fishbone, bar chart, scatter plot, pie chart, histogram, or heat map.

15. The method of claim 14, wherein the first instruction string further includes instructions to extract the user intent or the level of detail from the user prompt, or to infer the user intent or the level of detail from at least one of the semantic context or the diagram data.

16. The method of claim 14, wherein the first instruction string further includes instructions to iteratively extract the diagram data from the at least one of the text data item, the text transcripts, or the textual descriptions based on the semantic context and the user intent, and to generate the diagram of the digital content based on the diagram data and the user intent, until the diagram meets a threshold of representing the user intent.

17. A non-transitory computer readable medium on which are stored instructions that, when executed, cause a programmable device to perform functions of:
receiving, via a client device, a user prompt requesting a diagram representing digital content, wherein the digital content includes any of text, audio, video, or structured file;
constructing, via a prompt construction unit, a first prompt by appending the user prompt and the digital content to a first instruction string, the first instruction string including instructions to a generative model to identify semantic context of the digital content based on metadata of the digital content, to identify at least one of a text data item, an audio data item, a video data item, or a structured file item, embedded in the digital content to generate at least one of a text transcript of the audio data item, a text transcript of the video data item, a text transcript of the structured file item, a text description of the audio data item, a textual description of the video data item, or a text description of the structured file item, to semantically analyze and extract diagram data from at least one of the text data item, the text transcripts, or the textual descriptions based on the semantic context, and to generate the diagram of the digital content based on the diagram data;
providing, via the prompt construction unit, as an input the first prompt to the generative model and receiving as an output the diagram from the generative model; and
providing the diagram to the client device to be presented on a user interface of the client device.

18. The non-transitory computer readable medium of claim 17, wherein the first instruction string further includes instructions to determine a diagram type of the diagram based on at least one of the semantic context, the diagram data, a user intent, or a level of detail, and
wherein the diagram type is a timeline, flowchart, decision tree, mind map, organization chart, fishbone, bar chart, scatter plot, pie chart, histogram, or heat map.

19. The non-transitory computer readable medium of claim 18, wherein the first instruction string further includes instructions to extract the user intent or the level of detail from the user prompt, or to infer the user intent or the level of detail from at least one of the semantic context or the diagram data.

20. The non-transitory computer readable medium of claim 18, wherein the first instruction string further includes instructions to iteratively extract the diagram data from the at least one of the text data item, the text transcripts, or the textual descriptions based on the semantic context and the user intent, and to generate the diagram of the digital content based on the diagram data and the user intent, until the diagram meets a threshold of representing the user intent.
